(19) United States
(12) Patent Application Publication
(10) Pub. No.: US 2017/0228499 A1
(43) Pub. Date: Aug. 10, 2017

(54) METHOD AND A SYSTEM FOR TAKING CHARGE OF A PATIENT BY A HEALTH VEHICLE

(71) Applicant: Franck BAUDINO, Paris (FR)

(72) Inventor: Franck BAUDINO, Paris (FR)

(21) Appl. No.: 15/056,351

(22) Filed: Feb. 29, 2016

(30) Foreign Application Priority Data
Feb. 9, 2016 (FR) 1651016

(51) Int. Cl. G06F 19/00

(52) U.S. Cl. CPC G06F 19/322; G06F 19/3418

(57) ABSTRACT

The invention relates essentially to a method of taking charge of a patient by a health vehicle, the method being performed by a system comprising said health vehicle and a remote server, said health vehicle including an emergency situation indicator device, the method comprising the following steps:
the health vehicle obtaining (S400) data about the health of the patient;
transmitting (S410) said data to the remote server for analysis of said data; and
when the result of the analysis implies that the patient needs to be transported to a healthcare facility, said health vehicle transporting (S430) the patient to the healthcare facility (130); and
when the result of the analysis implies that the patient needs to be transported to a healthcare facility in urgent manner, putting into operation (S420) the emergency situation indicator device of said health vehicle.

### BACKGROUND OF THE INVENTION

The present invention relates to the field of health vehicles.

In known manner, a patient visits a medical practice or any other healthcare facility for consultation, for monitoring, and/or for care.

Nevertheless, the various constraints associated with making such a visit, such as for example distance, in particular in medical “deserts”, can lead to patients reducing the frequency of visits, or even deciding not to make a visit at all. Patient monitoring by the doctor then becomes irregular, having a negative effect on the patient's health.

A doctor or other health professional may also visit the patient at home, in particular when the patient is not capable of traveling.

Nevertheless, such visits take up a large amount of doctor time and can be difficult to organize, in particular if the doctor finds that the patient requires additional care that cannot be provided on site.

There therefore exists a need for a solution for taking charge of a patient while limiting doctor and patient travel.

### OBJECT AND SUMMARY OF THE INVENTION

To this end, the present invention provides a method of taking charge of a patient by a health vehicle, the method being performed by a system comprising the health vehicle and a remote server, the health vehicle including an emergency situation indicator device, the method comprising the following steps:
the health vehicle obtaining data about the health of the patient;
transmitting the data to the remote server for analysis of the data; and
when the result of the analysis implies that the patient needs to be transported to a healthcare facility, the health vehicle transporting the patient to the healthcare facility; and
when the result of the analysis implies that the patient needs to be transported to a healthcare facility in urgent manner, putting into operation the emergency situation indicator device of the health vehicle.

Thus, travel by the doctor or by the patient is limited, and the patient is transported to a healthcare facility only when that is necessary.

In a particular embodiment, the step of obtaining data about the health of the patient includes a substep of setting up communication between the patient and a health professional by means of a communications interface of the health vehicle.

In a particular embodiment, the step of obtaining data about the health of the patient includes a substep of measuring the data.

In a particular embodiment, a health professional acts remotely to start taking a measurement of the data.

In a particular embodiment, the step of obtaining data about the health of the patient includes a substep of obtaining data about an environmental condition of the health vehicle.

In a particular embodiment, the step of obtaining data about the health of the patient includes a substep of triggering an emergency alert, the data corresponding to the emergency alert.

In a particular embodiment, the step of transporting the patient includes a substep of putting into operation a device for assisting in driving the vehicle or a device for driving the vehicle automatically.

In a particular embodiment, the method further includes a step of transmitting a request to the remote server to send the health vehicle to an address.

In a particular embodiment, the method further comprises the following steps:
determining a remote medical center; and
transmitting the request to the remote medical center.

In a particular embodiment, the method further comprises the following steps:
selecting the health vehicle; and
causing the health vehicle to travel to the address specified in the request.

The invention also provides a system for taking charge of a patient by a health vehicle, the system comprising the health vehicle and a remote server, the health vehicle comprising:
an emergency situation indicator device;
means for obtaining data about the health of the patient; and
a communications interface adapted to transmit the data to the remote sever for analysis of the data;

whereby, when the result of the analysis implies that the patient needs to be transported to a healthcare facility, the system is adapted to transport the patient by the health vehicle to the healthcare facility, and

when the result of the analysis implies that the patient needs to be transported to a healthcare facility in urgent manner, the system is adapted to put into operation the emergency situation indicator device of the health vehicle.

### BRIEF DESCRIPTION OF THE DRAWINGS

Other characteristics and advantages of the present invention appear from the following description made with reference to the accompanying drawings, which show an embodiment having no limiting character. In the figures:

FIG. 1 is a diagram of a system for taking charge of a patient by a health vehicle according to an example of an embodiment of the invention;

FIG. 2 is a diagram showing a health vehicle of a system for taking charge of a patient by a health vehicle according to an example of an embodiment of the invention;

FIG. 3 is a diagram of a health vehicle of a system for taking charge of a patient by a health vehicle according to an example of an embodiment of the invention;

FIG. 4 is a flow chart showing the main steps of a method of taking charge of a patient by a health vehicle according to an example of an embodiment of the invention;

FIG. 5 is a flow chart showing the main steps of a method of taking charge of a patient by a health vehicle according to an example of an embodiment of the invention;

FIG. 6 is a flow chart of substeps of a step of obtaining data about the health of a patient in a method of taking charge of a patient by a health vehicle according to an example of an embodiment of the invention;

FIG. 7 is a flow chart showing substeps of a step of obtaining data about the health of a patient in a method of taking charge of a patient by a health vehicle according to an example of an embodiment of the invention; and

FIG. 8 is a diagram of a health vehicle in a system for taking charge of a patient by a health vehicle according to an example of an embodiment of the invention while transporting a patient to a healthcare facility.

### DETAILED DESCRIPTION OF EMBODIMENTS

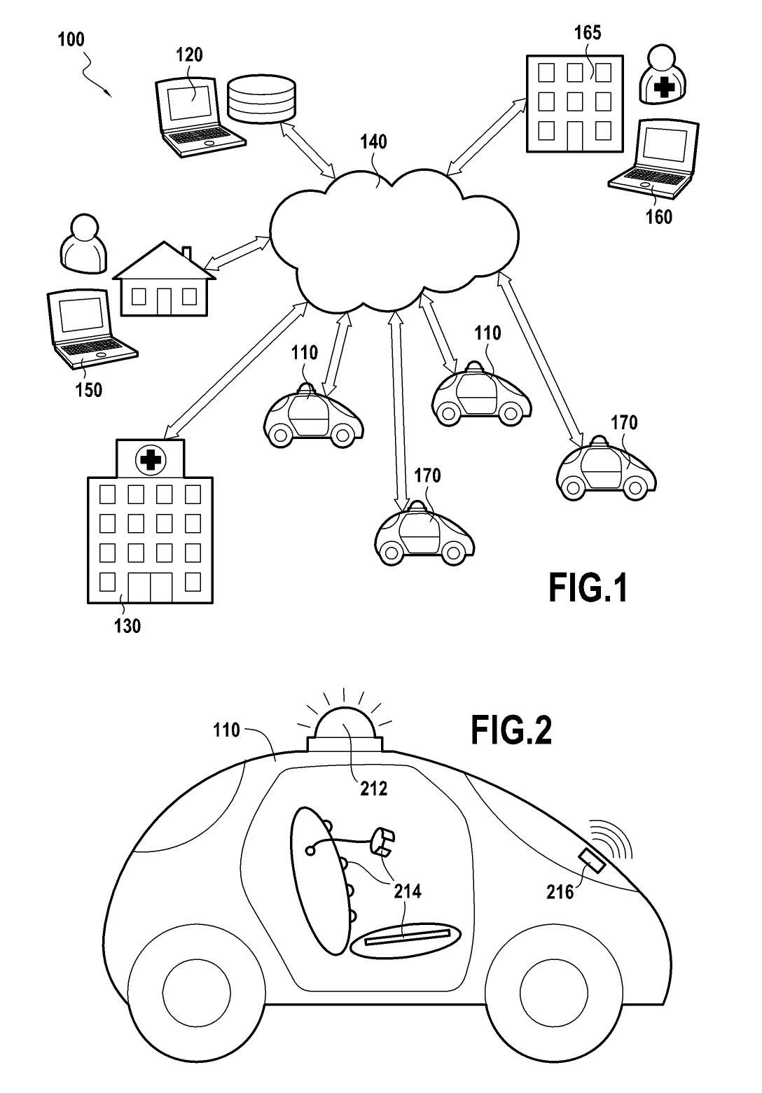

FIG. 1 is a diagram of a system 100 for taking charge of a patient by a health vehicle 110 according to an example of an embodiment of the invention. The system 100 comprises a health vehicle 110 and a remote server 120.

The health vehicle 110 includes an emergency situation indicator device 212, means 214 for obtaining data about the health of the patient, and a communications interface 216 adapted to transmit the data to the remote server 120 for analysis of the data (cf. FIG. 2).

When the result of the analysis implies that the patient needs to be transported to a healthcare facility 130, the system 100 is adapted to transport the patient by means of the health vehicle 110 to the healthcare facility 130.

When the result of the analysis implies that the patient needs to be transported to a healthcare facility 130 in urgent manner, the system is adapted to put into operation the emergency situation indicator device 212 of the health vehicle 110.

The term “healthcare facility” is used to cover a medical practice, a hospital, a clinic, and any other facility where it is possible to perform medical consultation, medical monitoring, and/or medical care.

In an example, the system 100 has a plurality of health vehicles 110.

In an example, the health vehicle 110 is a motor vehicle such as a car or a light utility vehicle.

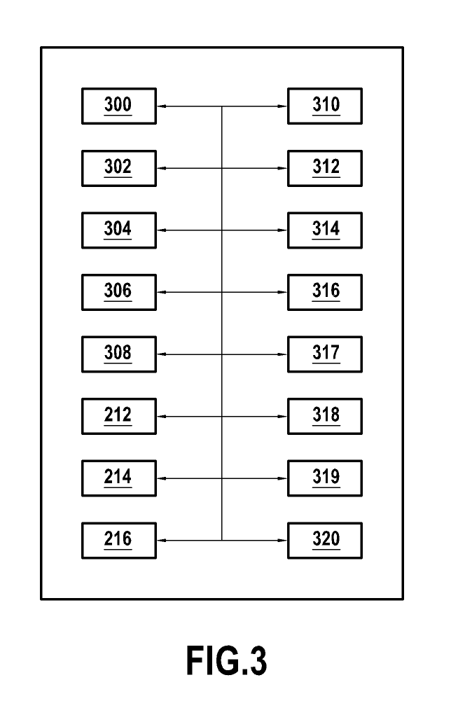

As shown in FIG. 3, the health vehicle 110 also includes a processor 300, an operating system 302, and may include a read only memory (ROM) 304, a rewritable non-volatile memory 306 (e.g. of the electrically erasable programmable read only memory (EEPROM) or flash NAND type), a rewritable volatile memory or random access memory (RAM) 308, a screen 310, a camera 312, a microphone 314, a loudspeaker 316, one or more environmental sensors 317, and/or patient identifier means 319.

The term “environmental sensor” is used to cover any sensor configured to measure data about a condition of the environment of the health vehicle 110, such as a level of noise, light, temperature, etc. By way of example, each environmental sensor 317 may be a thermometer, a hygrometer, a microphone, a photoelectric cell, etc.

By way of example, the patient identifier means 319 may be a reader for reading a health insurance card.

The screen 310, the camera 312, the microphone 314, and/or the loudspeaker 316 associated with the communications interface 216 can enable the patient to communicate with a remotely located health professional, e.g. by videoconference.

The emergency situation indicator device 212 serves to inform other vehicles and pedestrians encountered by the health vehicle 110 that the health vehicle 110 benefits from priority with respect to traffic regulations. The emergency situation indicator device 212 may comprise an emergency rotating light, a loudspeaker adapted to make a siren type sound, and/or an emergency signal transmitter module adapted to transmit an emergency signal about the health of the patient.

The means 214 for obtaining data about the health of the patient may comprise one or more medical instruments, such as a stethoscope, a dermatoscope, an otoscope, a retinoscope, an instrument for testing hearing, an instrument for testing sight, etc.

The means 214 for obtaining data about the health of the patient may also comprise one or more medical sensors such as a blood pressure monitor, scales, a thermometer, a pulse oxymeter, an electrocardiograph, a glucose monitor, a height gauge, etc.

The means 214 for obtaining data about the health of the patient may also comprise an emergency button or any other device for signaling an emergency.

Thus, the term “data about the health of a patient” covers any data measured by a medical instrument or a medical sensor that is capable of characterizing the state of the health of the patient, and also any data produced by a device for signaling an emergency, indicating that there is an emergency relating to the health of the patient.

Furthermore, the health vehicle 110 may include a device 318 for providing assistance in driving the vehicle and/or a device 320 for driving the vehicle automatically. The health vehicle 110 may also include a module for processing an emergency signal transmitted by an emergency signal transmitter module.

The system also includes a telecommunications network 140 such as an Internet network or a telephone network. The communications interface 216 is thus adapted to transmit data about the health of the patient to the remote server 120 via the network 140.

Furthermore, the system 100 may include at least one patient terminal 150 and may include at least one health professional terminal 160.

The patient terminal 150 presents the conventional architecture of a computer and in particular it comprises a processor, an operating system, a ROM, a rewritable non-volatile memory, a rewritable volatile memory, and a communications interface adapted to communicate via the telecommunications network 140.

Likewise, the health professional terminal 160 presents the conventional architecture of a computer and comprises in particular, a processor, an operating system, a ROM, a rewritable non-volatile memory, a rewritable volatile memory, and a communications interface adapted to communicate via the telecommunications network 140. The health professional terminal 160 may also include analyzer means, a screen, a camera, a microphone, a loudspeaker, and/or means for identifying the health professional.

The means for identifying the health professional may for example be a reader for reading a health professional card.

The health professional terminal 160 may form part of a remote medical center 165. The term “remote medical center” is used to cover a healthcare facility in which at least one health professional works. The term “health professional” covers for example a doctor, a nurse, etc.

Thus, the system 100 may include one or more remote medical centers 165, each remote medical center possibly having one or more health professional terminals 160. In an example, the healthcare facility 130 is a remote medical center 165.

The system 100 may also include at least one common vehicle 170 including a communications interface adapted to communicate via the telecommunications network 140 and a module for processing an emergency signal transmitted by an emergency signal transmitter module of a health vehicle 110, and possibly including a device for providing assistance in driving the vehicle and/or a device for driving the vehicle automatically

The term “common vehicle” is used to cover any vehicle that does not include means for obtaining data about the health of the patient.

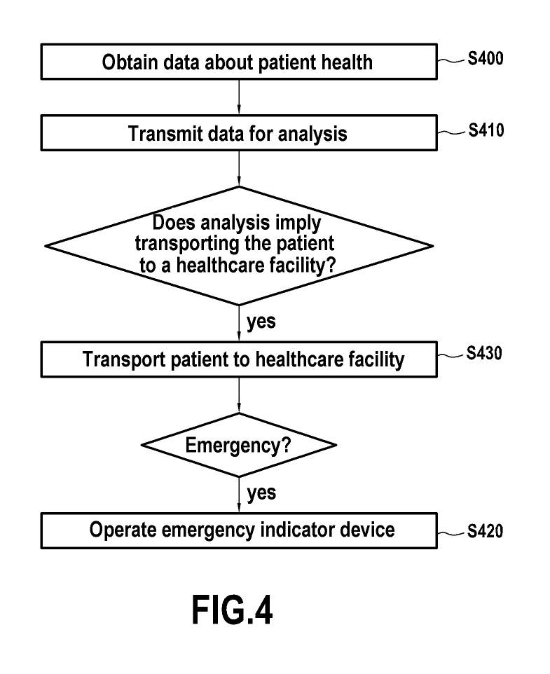

FIG. 4 shows a method of taking charge of a patient by a health vehicle 110 according to an example of an embodiment of the invention. The method is performed by a system 100 comprising the health vehicle 110 and a remote server 120, e.g. the system 100 of FIG. 1. The health vehicle 110 includes an emergency situation indicator device 212.

The method comprises a step S400 of the health vehicle 110 obtaining data about the health of the patient and a step S410 of transmitting the data to the remote server 120 for analysis of that data.

When the result of the analysis implies that the patient needs to be transported to a healthcare facility 130, the method includes a step S430 of the health vehicle 110 transporting the patient to the healthcare facility 130.

When the result of the analysis implies that the patient needs to be transported to a healthcare facility 130 in urgent manner, the method includes a step S420 of putting into operation the emergency situation indicator device 212 of the health vehicle 110.

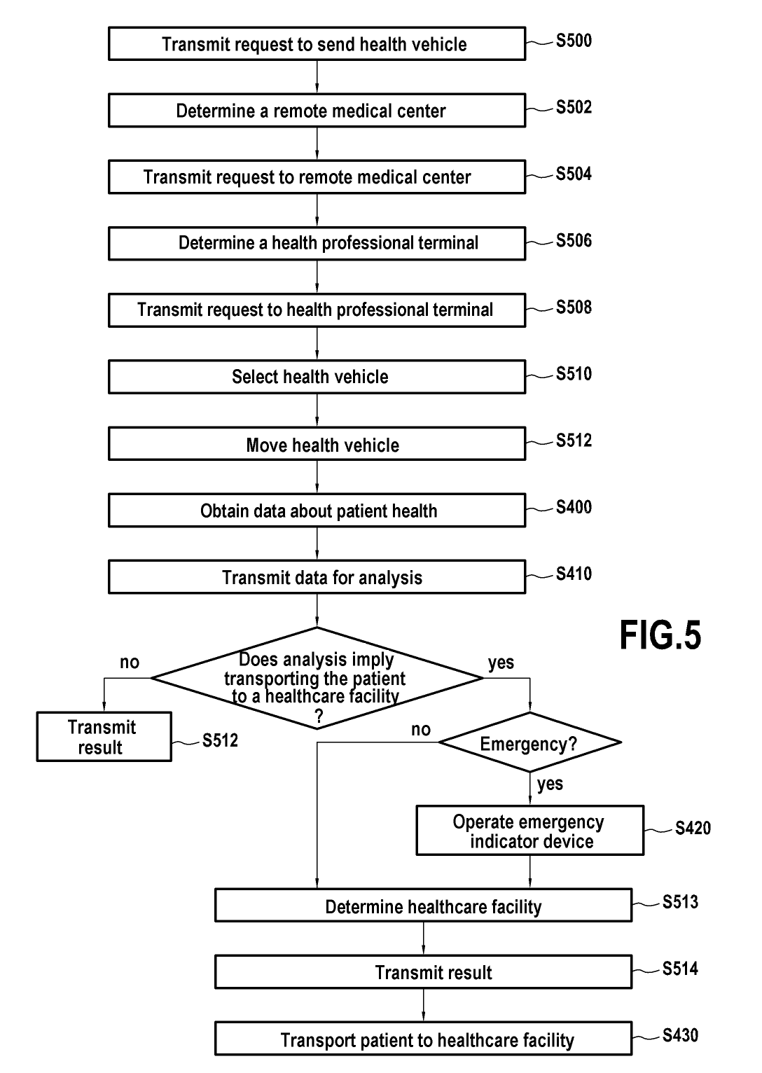

FIG. 5 shows a method of taking charge of a patient by a health vehicle 110 according to an example of an embodiment of the invention. The method is performed by a system 100 comprising the health vehicle 110 and a remote server 120, e.g. the system 100 of FIG. 1. The health vehicle 110 includes an emergency situation indicator device 212.

In a step S500, a request is transmitted to the remote server 120 to send the health vehicle 110 to an address.

By way of example, the request is issued by a patient terminal 150 used by the patient, and it is transmitted to the remote server 120 via a telecommunications network 140.

The step S500 may include a substep of connecting the patient terminal 150 to an Internet site and a substep of the patient inputting data, e.g. by filling in a form. By way of example, the data that is input may include: the address, i.e. an indication of the geographical location to which the health vehicle 110 is to be sent, e.g. the patient's home address. The step S500 may also include a substep of creating the request, which request may include at least some of the data input by the patient, and a substep of transmitting the request. By way of example, the substeps of creating and transmitting the request may be triggered by a mouse click on a button displayed on the Internet site.

In a variant, the transmission step S500 is performed by a health professional terminal 160 used by a health professional. In a variant, the transmission step S500 is performed by a device for taking a measurement once the device for taking a measurement has detected the need to send a health vehicle 110.

In an optional step S502, a remote medical center 165 is determined. More precisely, the remote server 150 determines one particular remote medical center 165 from a list of remote medical centers 165 that includes at least one remote medical center 165.

In an example, the remote medical center 165 is determined as a function of the distance between the remote medical center 165 and the address to which the health vehicle 110 is to be sent, and/or as a function of the availability of the remote medical center 165, e.g. as a function of the opening times of the remote medical center 165.

In an optional step S504, the request is transmitted to the remote medical center as determined in step S502.

More precisely, the request is transmitted by the remote server 120 to a terminal of the remote medical center 165. In a variant, the remote server 120 is a terminal of a predetermined remote medical center 165 and steps S502 and S504 are not performed.

In a step S506, a health professional terminal 160 is determined from a list of terminals that includes at least one health professional terminal 160. By way of example, the terminal 160 is determined as a function of the availability of the health professional using the terminal 160.

In a step S508, the request is transmitted to the terminal 160 as determined in step S406. The request may be transmitted by the remote server 120, or else by the terminal of the remote medical center when steps S504 and S506 are performed.

In a step s510, a health vehicle 110 is selected from a list that includes at least one health vehicle 110. This step S510 may be performed by the remote server 120.

The step S510 is performed automatically after receiving the request, or after the request has been validated by the health professional.

In an example, the health vehicle 110 is selected as a function of data such as a request from the patient, a decision of the health professional, the geographical location of each health vehicle 110 in the list, a map having data about the deployment zone of each health vehicle 110, such as street names, one-way streets, speed limits, etc., data about each health vehicle, such as the equipment on board the health vehicle, the configuration of the health vehicle, and the type of patient installation inside the health vehicle, the operating state of each health vehicle, the operating state of the medical instruments in each health vehicle, the availability of each health vehicle, and the state of traffic in real time.

Said data is received from each health vehicle 110 in the list and/or from one more external sources of information.

Thus, the sharing of the health vehicles 110 in the list that has at least one health vehicle 110 is optimized, and the patient's waiting time for the health vehicle is shortened.

In a step S512, the health vehicle 110 as selected in step S510 goes to the address given in the request.

The health vehicle 110 may be driven by a driver, possibly helped by a device 318 for providing assistance in driving the vehicle, or it may run without a driver, using a device 320 for automatically driving the vehicle. Once the health vehicle 110 has reached the address given in the request, the patient enters the health vehicle 110 and occupies a seat in the health vehicle 110. The patient can thus be taken in charge in the health vehicle 110.

The patient is identified by patient identifier means of the health vehicle 110, e.g. by reading a health insurance card.

In a step S400, at least one item of data about the health of the patient is obtained by the health vehicle 110, e.g. one or more such data items.

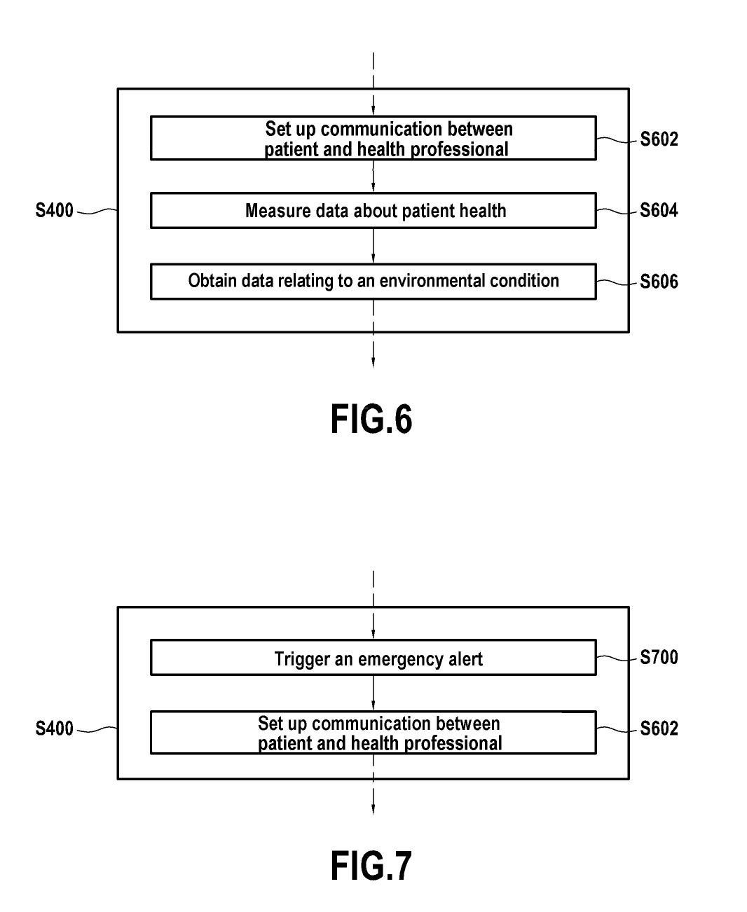

As shown in FIG. 6, the step S400 may comprise a substep S602 in which communication between the patient and a health professional is set up via a communications interface 216 of the health vehicle 110.

The health professional is preferably the health professional using the health professional terminal 160 as determined in step S506. The health professional may previously have been identified by health professional identifier means of the health professional terminal 160.

The communication is set up via the communications interface 216 of the health vehicle 110 and via a communications interface of the terminal 160. The patient and the health professional may also use a screen, a camera, a microphone, and/or a loudspeaker of the health vehicle 110 and/or of the terminal 160 in order to communicate, e.g. by videoconference.

Thus, data about the health of the patient is obtained under remote supervision by the health professional.

The step S400 may also include a substep S604 of measuring said data. This substep S604 is performed by means 214 of the health vehicle 110 for obtaining data about the health of the patient.

By way of example, these means 214 comprise one or more medical instruments and/or one or more medical sensors.

In order to obtain data about the health of the patient by means of a medical instrument, the health professional acts remotely to start measurement taking by the medical instrument. The health professional thus controls the taking of measurements by the medical instrument.

The patient's heart beat, data about the patient's skin, data about the patient's eardrum and meatus acousticus, data about the patient's eyes, the patient's capacity for hearing, and/or the patient's eyesight may in particular be measured by a medical instrument during substep S604.

In order to obtain data about the health of a patient by means of a medical sensor, the health professional acts remotely or the patient acts locally to start the taking of the measurement by the medical sensor.

The patient's blood pressure, weight, temperature, pulse, heart rhythm, blood oxygen capacity, electrocardiogram, glycemia, and/or height can all be measured by means of respective medical sensors during substep S604.

When the data about the patient's health is obtained by a medical sensor, step S602 of establishing communication between the health professional and the patient is not essential and it may be omitted. Substep S604 is then performed directly without remote supervision from the health professional.

In addition, step S400 may include a substep S606 of obtaining at least one item of data about an environmental condition, e.g. one or more such items of data.

The data relating to an environmental condition is measured by means of an environmental sensor 317. The temperature inside the health vehicle 110, the ambient noise level, and/or ambient light level may in particular be obtained by respective environmental sensors 317 during the substep S606.

In a variant, and as shown in FIG. 7, the step S400 may include a substep S700 of triggering an emergency alert, the data about the patient's health corresponding to said emergency alert. The alert may be triggered by pressing an emergency button, or by using other means for signaling an emergency. In this variant, the step S400 may also include the substep S602 in which communication is set up between the patient and a health professional by means of a communications interface 216 of the health vehicle 110.

In a step S410, the data about the patient's health is transmitted to the remote server 120 in order to analyze the data about the patient's health. The health professional as determined in step S506 can then consult the data in order to analyze it. In a variant, the data is analyzed automatically by analysis means, e.g. present in the health professional's terminal 160.

The data about an environmental condition may also be transmitted in step S410. The data about an environmental condition thus enables the health professional or the analysis means to interpret more accurately the data about the patient's health.

The result of the analysis by the health professional or by the analysis means need not imply transporting the patient to a healthcare facility 130, e.g. because the analysis indicates that the patient is in good health. The result of the analysis is then transmitted (step S512) to the health vehicle 110, and the health vehicle 110 communicates said result to the patient and informs the patient that he or she can leave the health vehicle 110. The health vehicle 110 can then leave the address at which it is located.

The result of the analysis by the health professional or by the analysis means need not imply transporting the patient to a healthcare facility 130 because the analysis indicates that the patient does not need any additional consultation. The result of the analysis is then transmitted (step S512) to the health vehicle 110, and a prescription may also be transmitted to the health vehicle 110.

The health vehicle 110 communicates said result and the prescription to the patient, e.g. by printing out the result and the prescription, and informs the patient that he or she may leave the health vehicle 110. The health vehicle 110 can then leave the address at which it is located.

The result of the analysis by the health professional or by the analysis means may imply that the patient needs to be transported to a healthcare facility 130, e.g. for additional consultation, to receive care, or for an operation.

When the result of the analysis implies that the patient needs to be transported to a healthcare facility 130, the method may include a step S513 of determining which healthcare facility 130 and a step S514 of transmitting the results to the health vehicle 110 and to the healthcare facility 130 as determined in step S513.

In an example, the remote server 150 or the health vehicle 110 determines the healthcare facility 130 from a list of healthcare facilities that includes at least one healthcare facility 130.

In an example, the healthcare facility 130 is determined as a function of the distance between the healthcare facility 130 and the health vehicle 110, the state of traffic in real time, and/or as a function of the availability of the healthcare facility 130, e.g. as a function of the opening times of the healthcare facility 130 and the availability of the health professional(s) at the healthcare facility 130. The healthcare facility 130 is then informed of the future arrival of the health vehicle 110, e.g. by making an appointment.

Furthermore, when the result of the analysis implies that the patient needs to be transported to a healthcare facility 130 in urgent manner, e.g. because the patient needs care or an operation immediately, the emergency situation indicator device 212 of the health vehicle 110 is put into operation in a step S420.

The emergency situation indicator device 212 serves to inform other vehicles or pedestrians encountered by the health vehicle 110 that the health vehicle 110 has priority with respect to traffic regulations. Thus, vehicles in the proximity of the health vehicle 110 can facilitate passage of the health vehicle 110.

In addition, when the result of the analysis implies that the patient needs to be transported to a healthcare facility 130, the method includes a step S430 of transporting the patient in the health vehicle 110 to the healthcare facility 130.

In an example, the step S430 includes a substep of starting a device 318 for providing assistance in driving the vehicle or a device 320 for driving the vehicle automatically.

Operating the device 320 for driving the vehicle automatically enables the patient to be taken automatically to the healthcare facility 130 without a driver acting directly on the main driving system of the health vehicle 110, i.e. its steering, engine speed, braking, etc.

The device 320 for automatically driving the vehicle thus takes account of the health vehicle 110 and the environment of the health vehicle 110, i.e. of the type, the technology, and the behaviors of vehicles traveling in the vicinity of the health vehicle 110.

In an example, the emergency situation indicator device 212 includes an emergency signal transmitter module that is adapted to transmit an emergency signal, and at least one vehicle in the proximity of the health vehicle 110 is a common vehicle 170 as described with reference to FIG. 1 and it includes means for processing the emergency signal. The health vehicle 110 can then interact with the common vehicle 170 in real time via the telecommunications network 140 in order to optimize the journey of the health vehicle 110.

The emergency signal may include information about the health vehicle 110, such as for example the position of the health vehicle 110, the speed of the health vehicle 110, the size of the health vehicle 110, the route being followed by the health vehicle 110, the nature of the health vehicle 110, and/or the priority level of the health vehicle 110.

When two health vehicles 110 are in the proximity of each other, the priority level makes it possible to determine which health vehicle 110 has priority over the other.

After the common vehicle 170 has received the emergency signal, the emergency signal processor module of the common vehicle 170 analyses the emergency signal and possibly obtains information about the health vehicle 110.

The common vehicle 170 can then inform the driver of the common vehicle 170 that a health vehicle 110 is nearby and can give the driver information about the health vehicle 110.

When the common vehicle 170 includes a device for providing assistance in driving the vehicle, the device for providing assistance in driving the vehicle may take account of the emergency signal, and thus of the information about the health vehicle 110, and give the driver advice on the actions to be performed in order to facilitate passage for the health vehicle 110 and thus optimize the journey of the health vehicle 110.

When the common vehicle 170 includes a device for driving the vehicle automatically, the device for driving the vehicle automatically may take account of the emergency signal and thus of the information about the health vehicle 110, and then automatically perform driving maneuvers in the common vehicle 170 so as to facilitate passage for the health vehicle 110 and thus optimize the journey of the health vehicle 110.

The device for automatically driving the vehicle or the device for providing assistance in driving the vehicle may take account not only of the emergency signal and thus of the information about the health vehicle 110, but also of the position(s) of nearby vehicle(s) other than the health vehicle 110, of the dimensions of nearby vehicle(s) other than the health vehicle 110, of the speed(s) of nearby vehicles other than the health vehicle 110, of the route(s) being followed by nearby vehicle(s) other than the health vehicle 110, of the map of nearby roads and streets, and of the characteristics of nearby roads and streets, all of this data being previously detected and determined by the common vehicle 170.

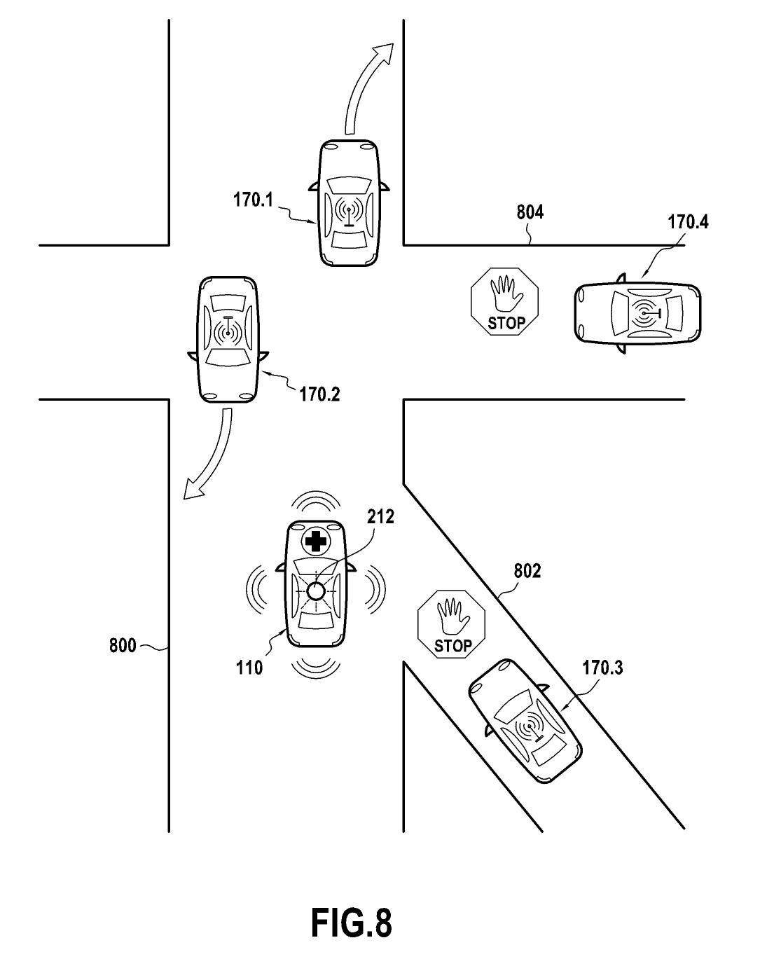

FIG. 8 is a diagram showing a health vehicle 110 of a system 100 according to an example of an embodiment of the invention, the vehicle transporting a patient to a healthcare facility 130. The emergency situation indicator device 212 of the health vehicle 110 is in operation, which indicator device 212 comprises an emergency transmitter module that is adapted to transmit an emergency signal.

The health vehicle 110 is running along a first road 800 behind a first common vehicle 170.1 of the system 100 that is traveling on the first road 800 and it is approaching a second common vehicle 170.2 of the system 100 that is oncoming on the first road 800.

A second road 802 and a third road 804 intersect the first road 800 near the health vehicle 110. On the second road 802 there is a third common vehicle 170.3 of the system 100, and on the third road 804 there is a fourth common vehicle 170.4 of the system 100, such that the third common vehicle 170.3 and the fourth common vehicle 170.4 are about to cross the path of the health vehicle 110.

Each common vehicle 170.1, 170.2, 170.3, and 170.4 has an emergency signal processor module and a device for driving the vehicle automatically.

The emergency signal processor module of each common vehicle 170.1, 170.2, 170.3, and 170.4 thus receives the emergency signal and analyses it. Thereafter, the device for automatically driving each common vehicle 170.1, 170.2, 170.3, and 170.4 automatically causes the corresponding common vehicle 170.1, 170.2, 170.3, and 170.4 to perform driving maneuvers that will facilitate passage for the health vehicle 110.

In this example, the device for automatically driving the first common vehicle 170.1 directs the first common vehicle 170.1 to leave enough space to allow the health vehicle 110 to pass, the device for automatically driving the second common vehicle 170.2 directs the second common vehicle 170.2 so as to leave enough space for the health vehicle 110 to pass, the device for automatically driving the third common vehicle 170.3 stops the third common vehicle 170.3, and the device for automatically driving the fourth common vehicle 170.4 stops the fourth common vehicle 170.4.

1. A method of taking charge of a patient by a health vehicle, the method being performed by a system comprising said health vehicle and a remote server, said health vehicle including an emergency situation indicator device, the method comprising the following steps:
the health vehicle obtaining data about the health of the patient;
transmitting said data to the remote server for analysis of said data; and
when the result of the analysis implies that the patient needs to be transported to a healthcare facility, said health vehicle transporting the patient to the healthcare facility; and
when the result of the analysis implies that the patient needs to be transported to a healthcare facility in urgent manner, putting into operation the emergency situation indicator device of said health vehicle.

2. A method according to claim 1, wherein the step of obtaining data about the health of the patient includes a substep of setting up communication between the patient and a health professional by means of a communications interface of said health vehicle.

3. A method according to claim 1, wherein the step of obtaining data about the health of the patient includes a substep of measuring said data.

4. A method according to claim 3, wherein a health professional acts remotely to start taking a measurement of said data.

5. A method according to claim 1, wherein the step of obtaining data about the health of the patient includes a substep of obtaining data about an environmental condition of the health vehicle.

6. A method according to claim 1, wherein the step of obtaining data about the health of the patient includes a substep of triggering an emergency alert, said data corresponding to said emergency alert.

7. A method according to claim 1, wherein the step of transporting the patient includes a substep of putting into operation a device for assisting in driving the vehicle or a device for driving the vehicle automatically.

8. A method according to claim 1, further including a step of transmitting a request to the remote server to send the health vehicle to an address.

9. A method according to claim 8, further comprising the following steps:
determining a remote medical center; and
transmitting the request to the remote medical center.

10. A method according to claim 8, further comprising the following steps:
selecting said health vehicle; and
causing said health vehicle to travel to the address specified in the request.

11. A system for taking charge of a patient by a health vehicle, the system comprising said health vehicle and a remote server, the health vehicle comprising:
an emergency situation indicator device;
means for obtaining data about the health of the patient; and
a communications interface adapted to transmit said data to the remote sever for analysis of said data;
whereby, when the result of the analysis implies that the patient needs to be transported to a healthcare facility, the system is adapted to transport the patient by said health vehicle to the healthcare facility; and
when the result of the analysis implies that the patient needs to be transported to a healthcare facility in urgent manner, the system is adapted to put into operation the emergency situation indicator device of said health vehicle.
